(19) United States
(12) Patent Application Publication
(10) Pub. No.: US 2025/0083764 A1
(43) Pub. Date: Mar. 13, 2025

(54) SADDLE-RIDE VEHICLE

(71) Applicant: HONDA MOTOR CO., LTD., Tokyo (JP)

(72) Inventors: Jun Tanaka, Wako-shi (JP); Tomoya Ohashi, Wako-shi (JP); Takashi Sasaki, Tokyo (JP); Keigo Mine, Tokyo (JP); Shunsuke Higo, Tokyo (JP); Yusuke Nagashima, Tokyo (JP)

(21) Appl. No.: 18/829,429

(22) Filed: Sep. 10, 2024

(30) Foreign Application Priority Data
Sep. 13, 2023 (JP) 2023-148441

(51) Int. Cl. B62J 17/10; B62J 43/16

(52) U.S. Cl. CPC B62J 17/10; B62J 43/16

(57) ABSTRACT

This saddle-ride vehicle includes: a shroud intake provided with a suction opening and disposed on the left and right sides of an energy storage unit, the shroud intake guiding traveling wind below a seat; and a shroud wing having a lower surface that guides traveling wind to the suction opening and an upper surface that causes the traveling wind to flow to the side of a vehicle body. The shroud wing includes a wing body portion further inward in the vehicle width direction than a side portion. The wing body portion includes a first pointed portion on the front side and inside in the vehicle width direction, and a second pointed portion on the rear side and outside in the vehicle width direction. The wing body portion, the suction opening, the energy storage unit are arranged in this order from the front in a vehicle body side view.

### INCORPORATION BY REFERENCE

The present application claims priority under 35 U.S.C. § 119 to Japanese Patent Application No. 2023-148441 filed on Sep. 13, 2023. The content of the application is incorporated herein by reference in its entirety.

### BACKGROUND

### Technical Field

The present invention relates to a saddle-ride vehicle.

### Related Art

Conventionally, a saddle-ride vehicle including wings is known (see, for example, Japanese Patent No. 7191907). In the saddle-ride vehicle disclosed in Japanese Patent No. 7191907, a pair of right and left wing portions as wings are provided at outer end portions of a cowl in the vehicle width direction, and downforce is obtained by the wing portions. In Japanese Patent No. 7191907, an intake port for air intake is formed between the left and right wing portions. The intake port in Japanese Patent No. 7191907 is formed forward of a fuel tank and is formed in the front of the vehicle body.

### SUMMARY

Meanwhile, in Japanese Patent No. 7191907, an intake port serving as a suction opening is provided in the front surface of the cowl, but in some saddle-ride vehicles, easy inflow of traveling wind into the suction opening may result in excessive air intake. Therefore, even if the suction opening is formed in the front of the vehicle body, it has been required to adjust the amount of traveling wind flowing into the suction opening. Furthermore, as a general problem, in order to reduce the fatigue of a rider, it is desirable to prevent the traveling wind from hitting the rider.

The present invention has been made in view of the above circumstances, and an object of the present invention is to provide a saddle-ride vehicle in which even if the suction opening is provided in the front of the vehicle body, a necessary and sufficient amount of intake air is easily obtained, and the traveling wind is prevented from hitting a rider.

A saddle-ride vehicle includes an energy storage unit, a shroud wing, and a shroud intake. The shroud intake is provided with a suction opening and disposed on the left and right sides of the energy storage unit. The shroud intake guides traveling wind below a seat. The shroud wing is disposed forward of the shroud intake and has a shroud wing upper surface and a shroud wing lower surface. The shroud wing lower surface guides traveling wind to the suction opening. The shroud wing upper surface causes the traveling wind to flow to the side of a vehicle body. The shroud wing includes a wing body portion further inward in the vehicle-body width direction than a shroud wing side portion. The wing body portion includes a first pointed portion on the front side in the vehicle-body front-rear direction and on the inside in the vehicle-body width direction, and a second pointed portion on the rear side in the vehicle-body front-rear direction and on the outside in the vehicle-body width direction. The wing body portion, the suction opening, and the energy storage unit are arranged in this order from the front in a vehicle body side view.

It is possible to provide the saddle-ride vehicle in which even if a suction opening is provided in the front of the vehicle body, a necessary and sufficient amount of intake air is easily obtained and the traveling wind is prevented from hitting the rider.

### BRIEF DESCRIPTION OF DRAWINGS

FIG. 1 is a side view of a saddle-ride vehicle according to an embodiment of the present invention;

FIG. 2 is a perspective view of the saddle-ride vehicle from the upper left side;

FIG. 3 is a perspective view illustrating the main portion of the saddle-ride vehicle;

FIG. 4 is a diagram with tank shrouds removed from FIG. 3;

FIG. 5 is a rear upper perspective view of the saddle-ride vehicle illustrating the periphery of a seat;

FIG. 6 is a left front perspective view of a left tank shroud;

FIG. 7 is a left rear perspective view of the left tank shroud;

FIG. 8 is a side view of the left tank shroud viewed from the outside in the vehicle width direction;

FIG. 9 is a side view of the left tank shroud viewed from the inside in the vehicle width direction;

FIG. 10 is a plan view of the left tank shroud;

FIG. 11 is a bottom view of the left tank shroud;

FIG. 12 is a front view of the left tank shroud;

FIG. 13 is a plan view of the main portion of the saddle-ride vehicle;

FIG. 14 is a front view of the main portion of the saddle-ride vehicle;

FIG. 15 is an enlarged view of FIG. 1 illustrating the periphery of the tank shroud; and

FIG. 16 is a functional explanatory diagram of the present embodiment.

### DETAILED DESCRIPTION

Hereinafter, embodiments of the present invention will be described with reference to the drawings. Note that, in the description, directions such as front, rear, left, right, up and down are identical to directions with respect to a vehicle body, unless otherwise specified. In addition, reference sign FR in each drawing indicates the front side of the vehicle body, reference sign UP indicates the upper side of the vehicle body, and reference sign LH indicates the left side of the vehicle body.

### EMBODIMENT

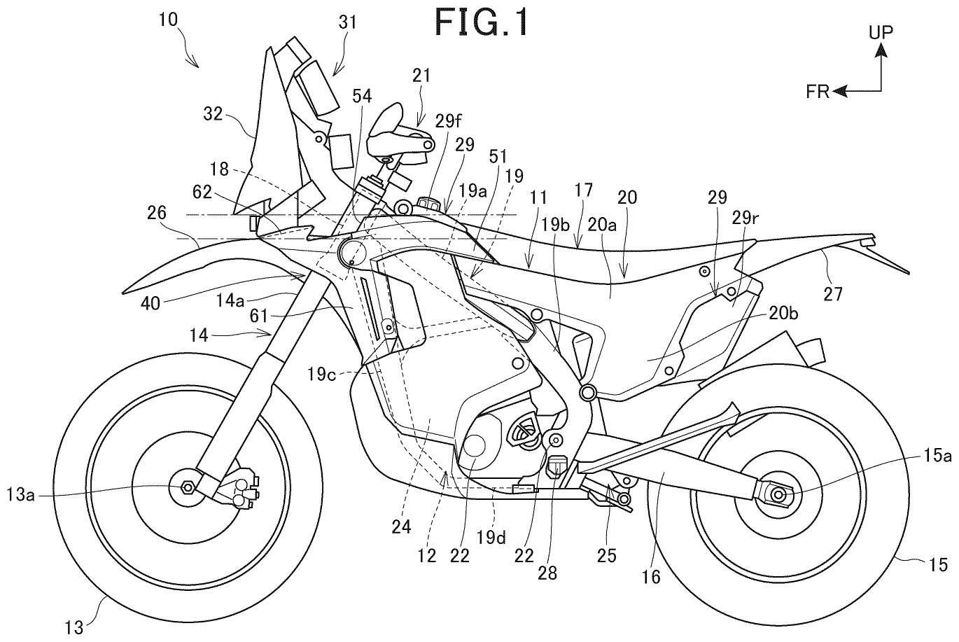

FIG. 1 is a side view of a saddle-ride vehicle 10 according to an embodiment of the present invention.

The saddle-ride vehicle 10 includes a vehicle body frame 11, a power unit 12 supported by the vehicle body frame 11, a front fork 14 that supports a front wheel 13 in a steerable manner, a swing arm 16 that supports a rear wheel 15, and a seat 17 for an occupant.

The saddle-ride vehicle 10 is a vehicle in which the occupant sits astride the seat 17. The seat 17 is provided above the rear portion of the vehicle body frame 11.

The vehicle body frame 11 includes a head pipe 18 provided at a front end portion of the vehicle body frame 11, a front frame 19 located behind the head pipe 18, and a rear frame 20 located behind the front frame 19. A front end portion of the front frame 19 is connected to the head pipe 18.

The seat 17 is supported by the rear frame 20.

The front fork 14 is supported by the head pipe 18 so as to be steerable to the left and right. The front wheel 13 is supported by an axle 13a, which is provided at a lower end portion of the front fork 14. A steering handlebar 21 to be gripped by the occupant is attached to an upper end portion of the front fork 14.

The swing arm 16 is supported by a pivot shaft 22, which is supported by the vehicle body frame 11. The pivot shaft 22 extends horizontally in the vehicle width direction. The pivot shaft 22 is inserted into a front end portion of the swing arm 16. The swing arm 16 swings up and down about the pivot shaft 22.

The rear wheel 15 is supported by an axle 15a, which is provided at a rear end portion of the swing arm 16.

The power unit 12 is disposed between the front wheel 13 and the rear wheel 15, and is supported by the vehicle body frame 11.

The power unit 12 is an internal combustion engine. The power unit 12 includes a crankcase 23 and a cylinder portion 24 that accommodates a reciprocating piston. An exhaust device 25 is connected to the exhaust port of the cylinder portion 24.

The output of the power unit 12 is transmitted to the rear wheel 15 by a drive transmission member that interconnects the power unit 12 and the rear wheel 15.

The saddle-ride vehicle 10 also includes a front fender 26 that covers the front wheel 13 from above, a rear fender 27 that covers the rear wheel 15 from above, a step 28 on which the occupant is to place his or her feet, and a fuel tank 29 that stores fuel to be used by the power unit 12.

The front fender 26 is attached to the front fork 14. The rear fender 27 and the step 28 are provided below the seat 17. The fuel tank 29 is supported by the vehicle body frame 11.

In the present embodiment, the front frame 19 has a pair of left and right main frame portions 19a, a pair of left and right pivot frame portions 19b extending downward from the rear ends of the main frame portions 19a while curving, a down frame portion 19c extending downward from the head pipe 18, and a pair of left and right lower frame portions 19d extending rearward from the lower end of the down frame portion 19c and connected to the lower ends of the pivot frame portions 19b.

In the present embodiment, the front frame 19 is formed from metal.

The rear frame 20 has a pair of left and right seat frame portions 20a extending in a band shape in the front-rear direction in a side view, and sub frame portions 20b extending from the pivot frame portions 19b to the seat frame portions 20a. The seat frame portions 20a are located outwardly of the main frame portions 19a in the vehicle width direction. The seat frame portions 20a of the rear frame 20 are connected to upper end portions of the pivot frame portions 19b. In addition, the sub frame portions 20b of the rear frame 20 are connected to the intermediate portions of the pivot frame portions 19b.

In the present embodiment, the rear frame 20 is formed from carbon fiber reinforced plastics (CFRP).

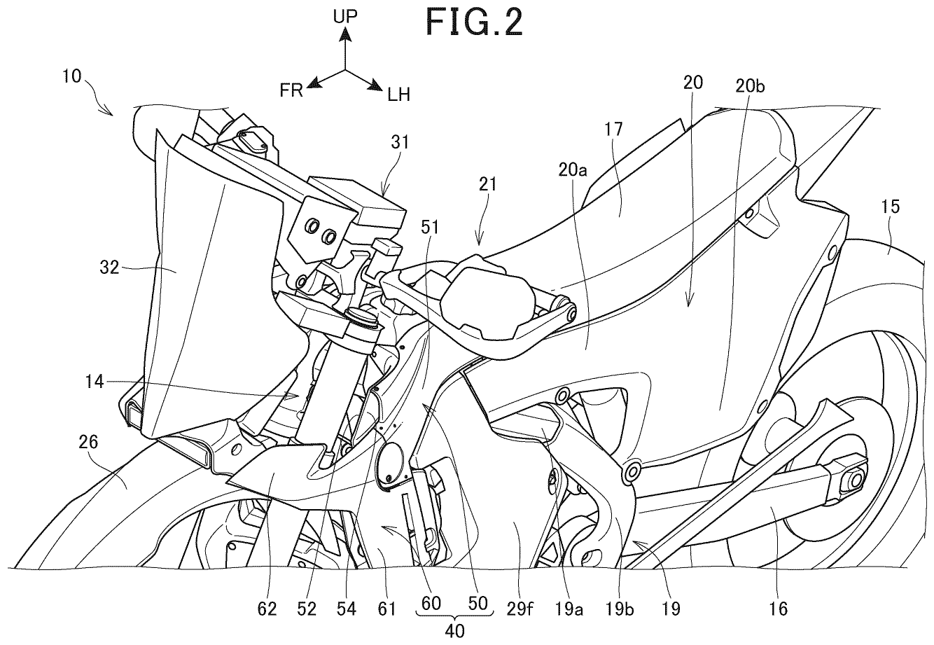

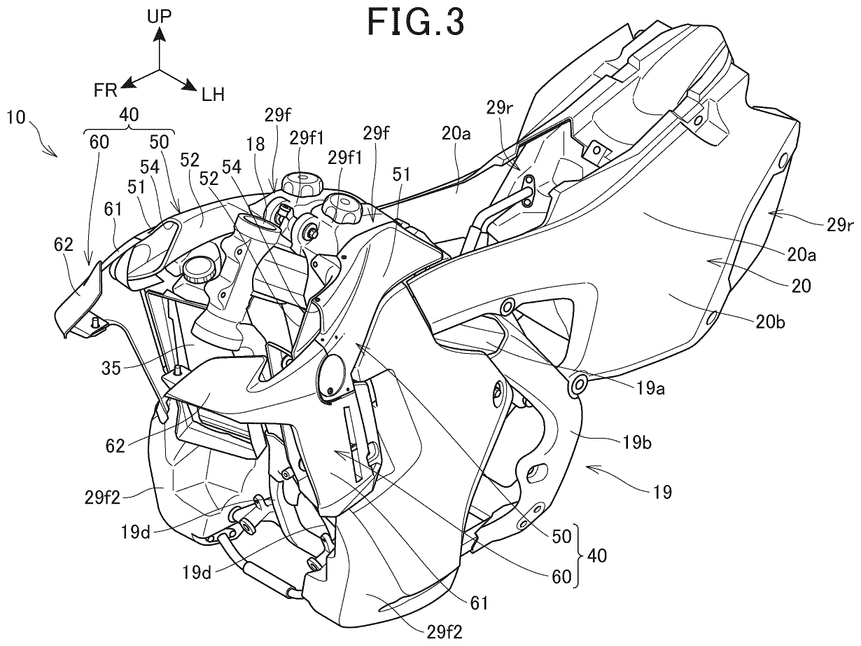

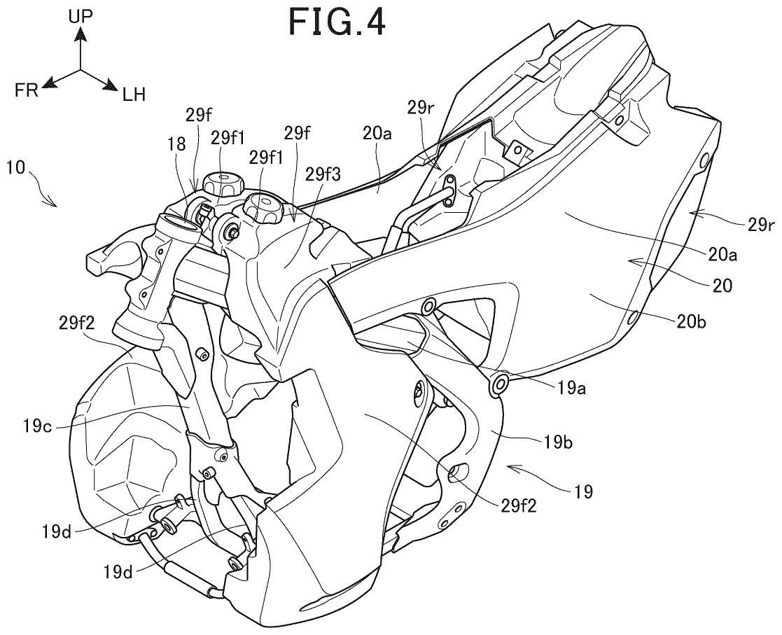

FIG. 2 is a perspective view of the saddle-ride vehicle 10 from the upper left side. FIG. 3 is a perspective view illustrating the main portion of the saddle-ride vehicle 10. FIG. 4 is a diagram with tank shrouds 40 removed from FIG. 3.

The saddle-ride vehicle 10 has a meter unit 31. The meter unit 31 is supported on the front side of the handlebar 21. The meter unit 31 is covered with a front screen 32 from the front.

As illustrated in FIG. 4, a pair of left and right front tanks (energy storage units) 29f are supported by the pair of left and right main frame portions 19a. The front tanks 29f are symmetrically formed. Each of the front tanks 29f has a vertically long container shape. The front tank 29f is disposed at a front end portion of the main frame portion 19a so as to extend from the upper portion of the main frame portion 19a to the outside in the vehicle width direction. The front tank 29f extends downward from above the main frame portion 19a. The front tank 29f includes a tank upper portion 29f1 on the inner side in the vehicle width direction and a tank lower portion 29f2 extending downward from the lower portion of the tank upper portion 29f1. The tank lower portion 29f2 bulges further outward in the vehicle width direction than the tank upper portion 29f1. Thus, the outer surface of the tank upper portion 29f1 and the upper surface of the tank lower portion 29f2 form a recess 29f3 that is recessed inward in the vehicle width direction. The recess 29f3 extends in the front-rear direction.

A pair of left and right rear tanks 29r are provided behind the front tanks 29f. The rear tanks 29r are supported by the rear frame 20. Specifically, the rear tanks 29r are supported by the seat frame portions 20a and the sub frame portions 20b. The rear tanks 29r are connected to the front tanks 29f through fuel pipes.

In the present embodiment, the front tanks 29f and the rear tanks 29r constitute the fuel tank 29.

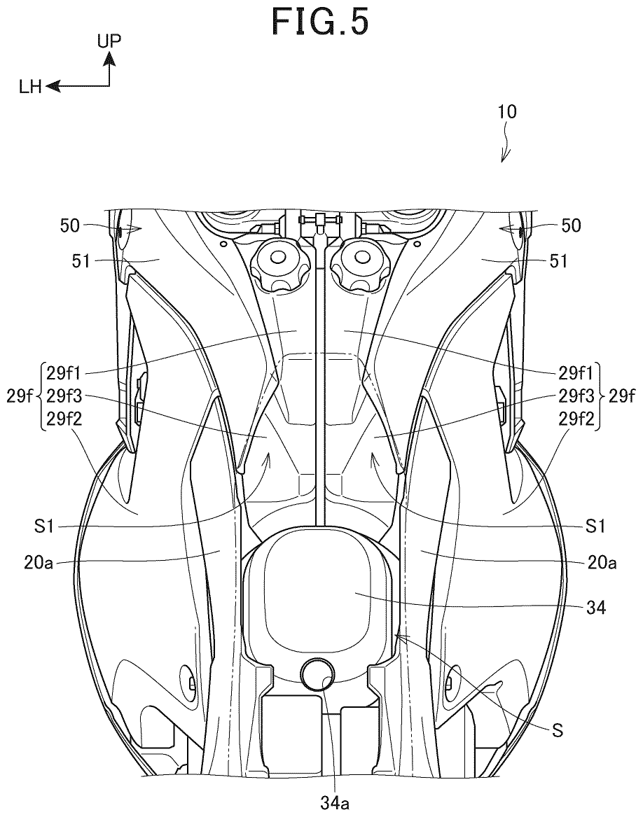

FIG. 5 is a rear upper perspective view of the saddle-ride vehicle 10 illustrating the periphery of the seat 17.

An air cleaner box 34 is disposed between the front tanks 29f and the rear tanks 29r. The air cleaner box 34 is disposed below the seat 17. Therefore, when the seat 17 is removed from the saddle-ride vehicle 10, the air cleaner box 34 is exposed upward from between the pair of left and right seat frame portions 20a. The air cleaner box 34 includes an intake port 34a at the center in the vehicle width direction. The intake port 34a opens rearward. The air cleaner box 34 takes in air from an intake space S below the seat 17. The intake space S is sandwiched between the pair of left and right seat frame portions 20a.

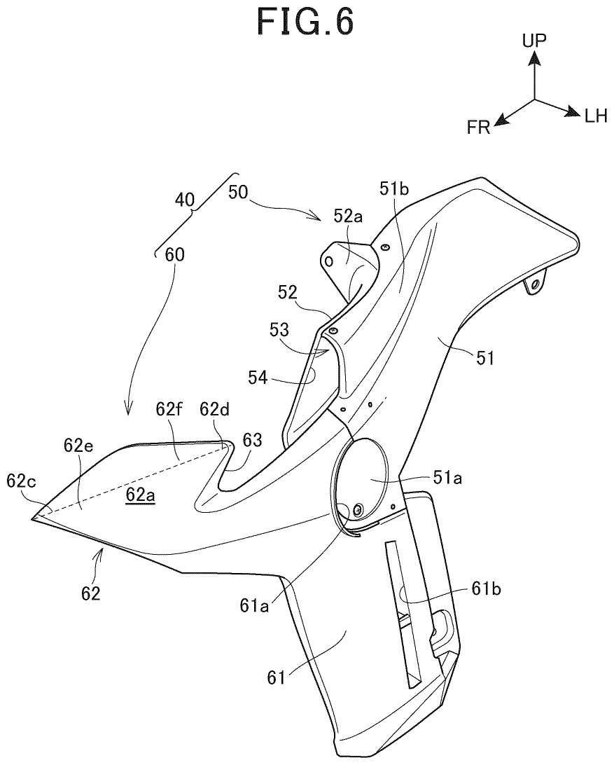

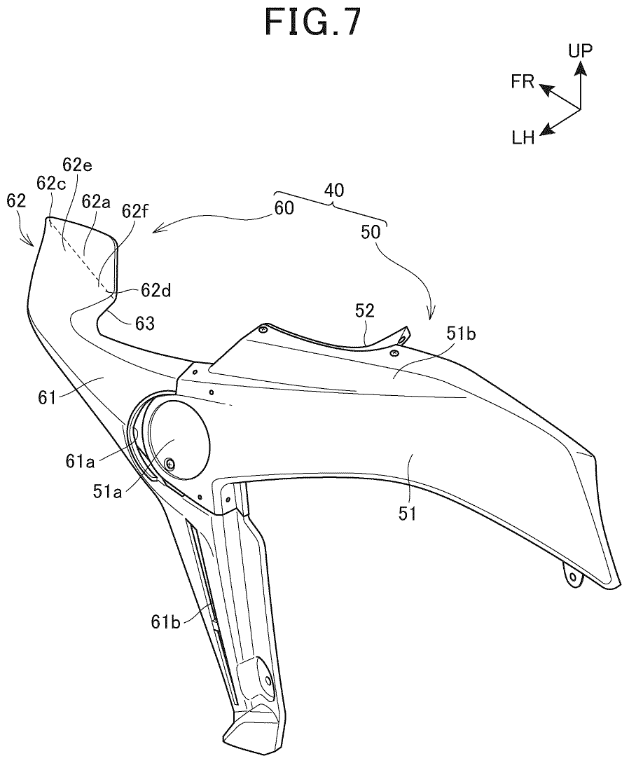

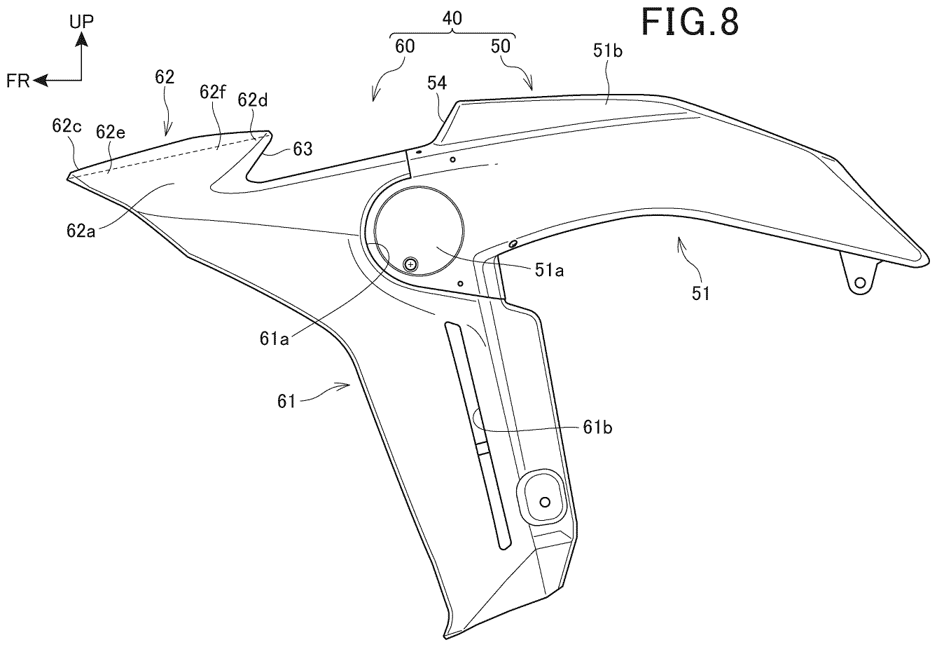

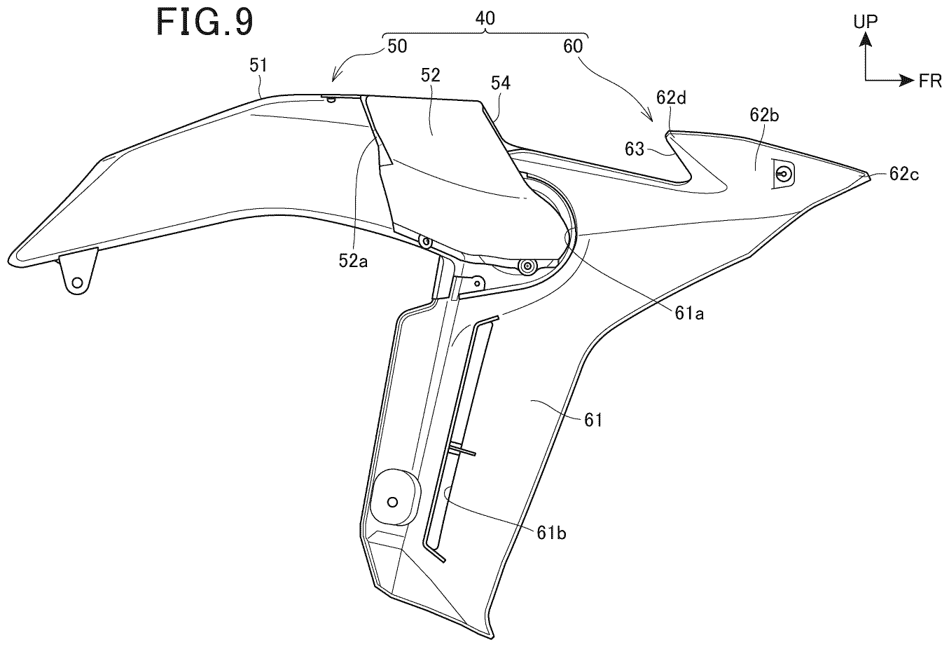

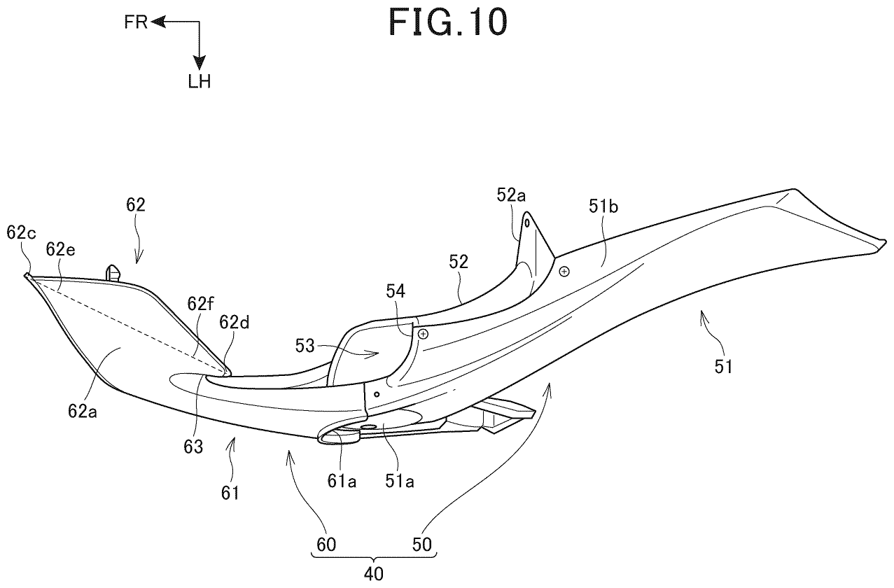

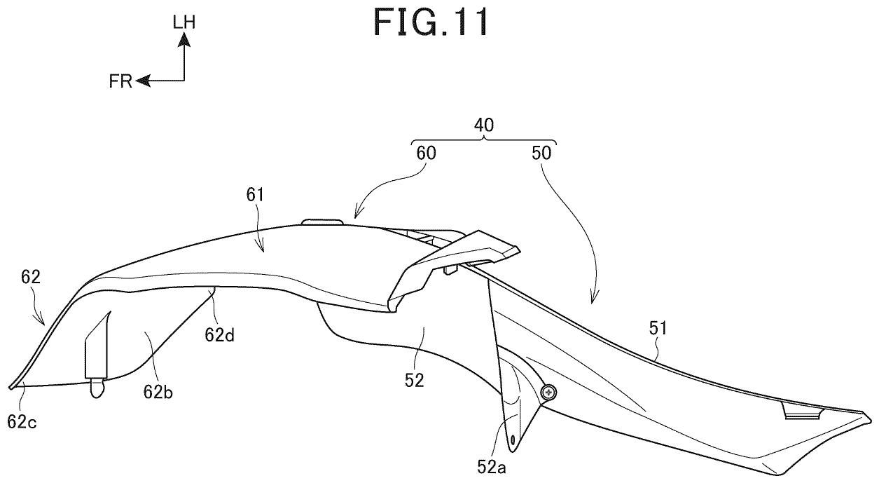

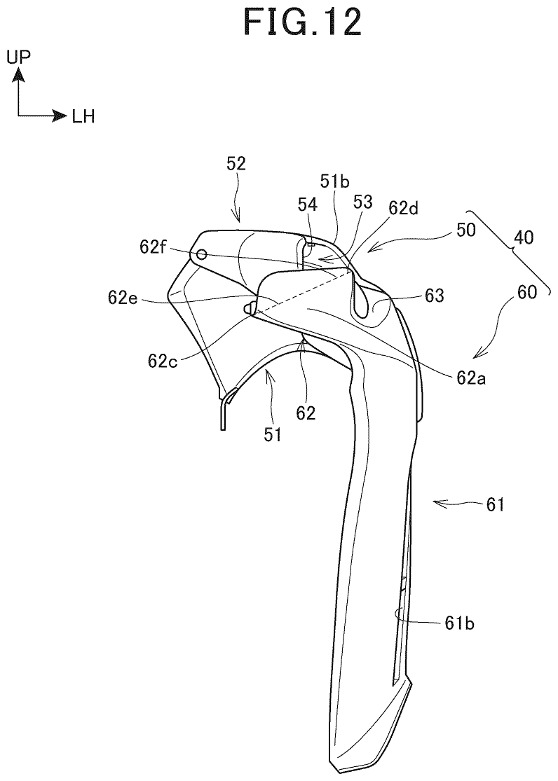

FIG. 6 is a left front perspective view of a left tank shroud 40. FIG. 7 is a left rear perspective view of the left tank shroud 40. FIG. 8 is a side view of the left tank shroud 40 viewed from the outside in the vehicle width direction. FIG. 9 is a side view of the left tank shroud 40 viewed from the inside in the vehicle width direction. FIG. 10 is a plan view of the left tank shroud 40. FIG. 11 is a bottom view of the left tank shroud 40. FIG. 12 is a front view of the left tank shroud 40.

The tank shrouds 40 are provided outwardly of the left and right front tanks 29f in the vehicle width direction.

Each of the tank shrouds 40 has a shroud intake 50 disposed outwardly of the front tank 29f in the vehicle width direction, and a shroud wing 60 disposed forward of the shroud intake 50.

The shroud intake 50 covers the front tank 29f from the outside in the vehicle width direction. The shroud intake 50 includes an outer shroud portion 51 constituting the outer surface of the vehicle body, and an inner shroud portion 52 connected to the inner side of the outer shroud portion 51 in the vehicle width direction.

The outer shroud portion 51 extends in the front-rear direction. The outer shroud portion 51 has an arc-shaped connection portion 51a in a side view. The outer shroud portion 51 has an upper portion 51b curved inward in the vehicle width direction. The outer shroud portion 51 is disposed above the tank lower portion 29f2 and covers the tank upper portion 29f1 from the outside in the vehicle width direction. That is, the outer shroud portion 51 is supported so as to cover the recess 2913 from the outside in the vehicle width direction. As a result, a duct portion S1 (see FIG. 5) extending in the front-rear direction is formed by the side surface of the front tank 29f and the outer shroud portion 51. The duct portion S1 communicates with the intake space S. The rear portion of the outer shroud portion 51 extends to a front end portion of the seat frame portion 20a along the seat frame portion 20a (see FIG. 1).

The inner shroud portion 52 is connected to a front end portion of the outer shroud portion 51 from the inside in the vehicle width direction. The inner shroud portion 52 is connected to the upper portion 51b and lower portion of the outer shroud portion 51. The inner shroud portion 52 is connected to face the outer shroud portion 51. As a result, a tubular duct 53 (see FIG. 6) extending in the front-rear direction is formed between the outer shroud portion 51 and the inner shroud portion 52. The shape surrounded by the front edges of the outer shroud portion 51 and the inner shroud portion 52 forms a suction opening 54 serving as the inlet of the duct 53. A fixing portion 52a bent inward in the vehicle width direction is formed at the rear end of the inner shroud portion 52. The fixing portion 52a is fixed to the front surface of the tank upper portion 29f1 of the front tank 29f. As a result, the duct 53 communicates with the duct portion S1 formed by the outer shroud portion 51 and the recess 2913 of the front tank 29f.

The shroud wing 60 is connected to the front side of the shroud intake 50. The shroud wing 60 has a shroud side surface portion (shroud wing side portion) 61 extending in the vertical direction, and a wing body portion 62 formed at the front end of the shroud side surface portion 61.

The shroud side surface portion 61 is formed with an arc-shaped connection portion 61a recessed forward from the rear edge. The connection portion 61a is connected to the shroud intake 50 with the connection portion 51a of the shroud intake 50 entering the connection portion 61a. A slit 61b extending in the vertical direction is formed below the connection portion 61a.

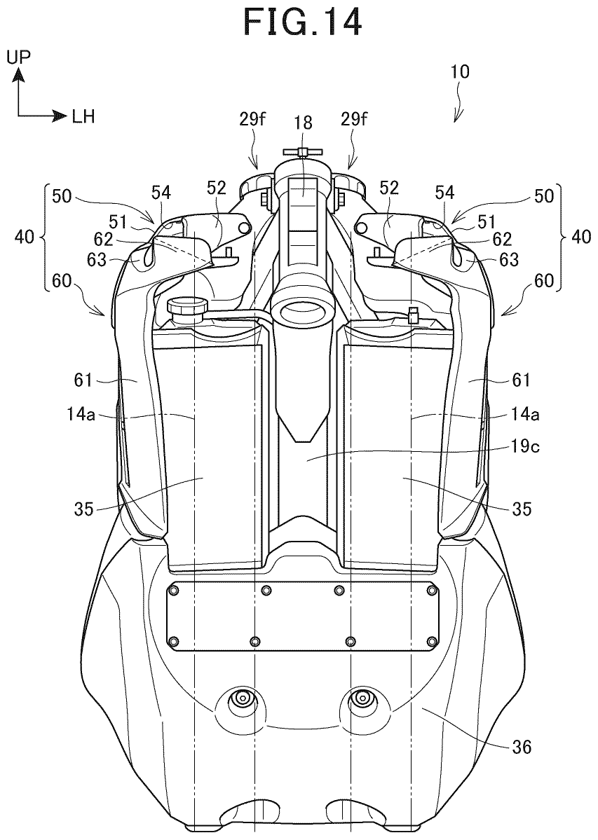

The wing body portion 62 curved inward in the vehicle width direction is supported at the upper front end of the shroud side surface portion 61. The wing body portion 62 is formed in a sweptback wing shape with respect to the shroud side surface portion 61. That is, when the shroud side surface portion 61 is viewed as a fuselage body, the wing body portion 62 has a sweptback wing shape with respect to the fuselage body. In other words, a notch 63 that tapers forward is formed between the wing body portion 62 and the shroud side surface portion 61. The wing body portion 62 is located further inward in the vehicle width direction than the shroud side surface portion 61. The wing body portion 62 is disposed forward of a fork tube 14a of the front fork 14. The wing body portion 62 partially overlaps the fork tube 14a in front view (see FIG. 14).

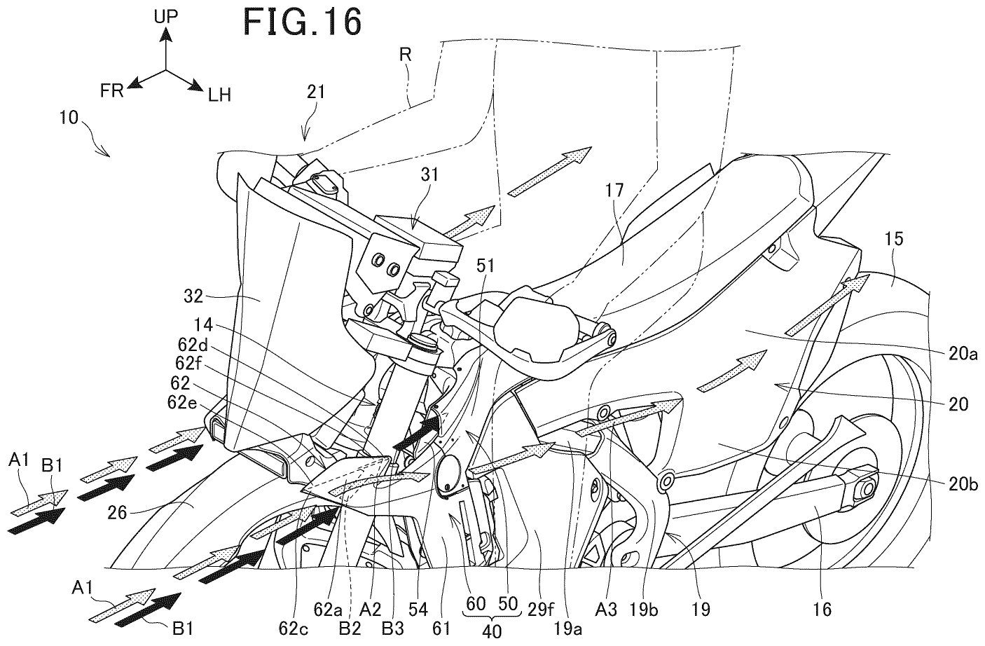

The wing body portion 62 has a substantially plate shape having an upper surface (shroud wing upper surface) 62a and a lower surface (shroud wing lower surface) 62b and having a substantially constant thickness. The wing body portion 62 is formed with the upper surface 62a to cause the traveling wind along the upper surface 62a to flow to the side of a rider R (see FIG. 16), which is an example of the side of the saddle-ride vehicle 10, and the lower surface 62b to guide the traveling wind along the lower surface 62b to the suction opening 54.

In the present embodiment, the wing body portion 62 has a front inner pointed portion (first pointed portion) 62c on the front side in the vehicle-body front-rear direction and on the inside in the vehicle-body width direction. The front inner pointed portion 62c is formed to taper forward in the vehicle-body front-rear direction and inward in the vehicle-body width direction. The wing body portion 62 also has a rear outer pointed portion (second pointed portion) 62d on the rear side in the vehicle-body front-rear direction and on the outside in the vehicle-body width direction. The rear outer pointed portion 62d tapers rearward in the vehicle-body front-rear direction and outward in the vehicle-body width direction. In other words, the notch 63 is formed between the rear outer pointed portion 62d and the shroud side surface portion 61.

The wing body portion 62 is inclined upwardly toward the rear of the vehicle body (see FIGS. 8 and 12). Furthermore, the wing body portion 62 is inclined upwardly toward the inside in the vehicle-body width direction (see FIGS. 6 to 8, 10, and 12). In the present embodiment, the wing body portion 62 is continuously curved and inclined. In other words, in the present embodiment, the wing body portion 62 is smoothly curved and inclined. The wing body portion 62 changes its angle from a gentle slope 62e to a steeper slope 62f with respect to the horizontal plane from the front inner pointed portion 62c toward the rear outer pointed portion 62d. More specifically, in each of FIGS. 6 to 12 and the like, the auxiliary line connecting the front inner pointed portion 62c and the rear outer pointed portion 62d is indicated by a broken line. The auxiliary line is illustrated linearly in each drawing for convenience. The angle changes from the gentle slope 62e to the steeper slope 62f in proceeding from the front inner pointed portion 62c to the rear outer pointed portion 62d along the auxiliary line.

In the present embodiment, the shroud intake 50 is formed from CFRP. The shroud wing 60 is formed from polypropylene (PP). In the shroud wing 60, the wing body portion 62 is supported in a cantilever shape with respect to the shroud side surface portion 61. Here, since the shroud wing 60 is formed from PP, when the shroud wing 60 comes into contact with the ground or the like, the shroud wing 60 can be easily bent to absorb shock easily and resist cracking.

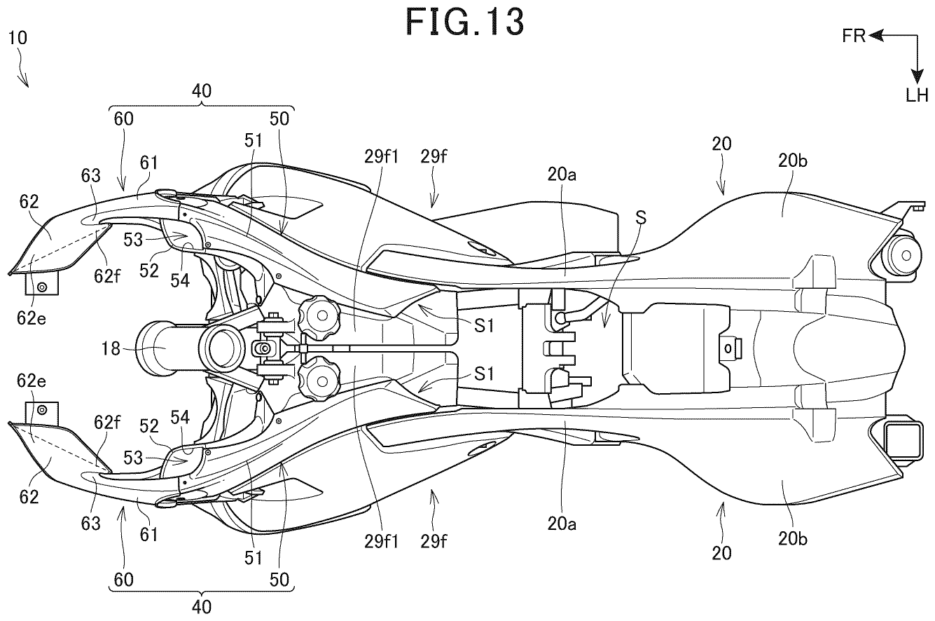

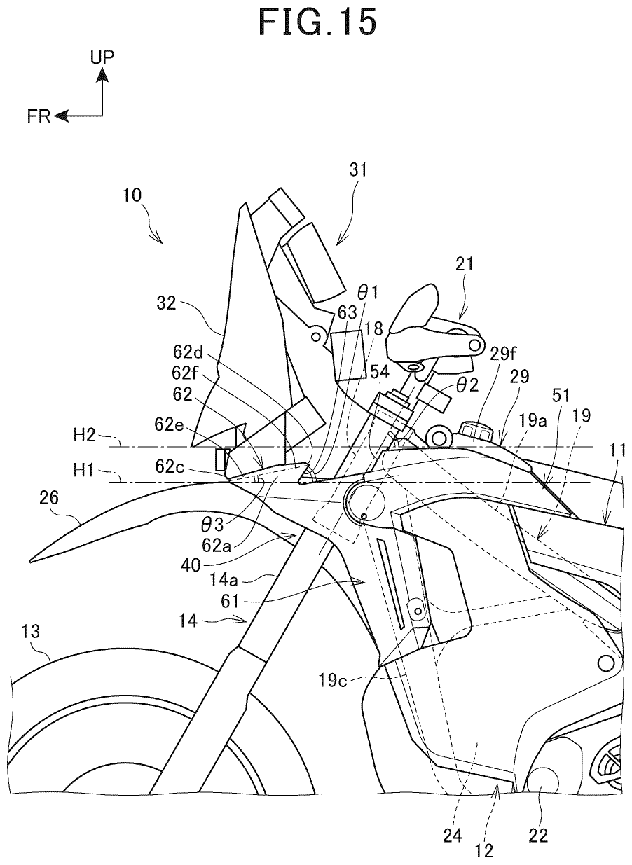

FIG. 13 is a plan view of the main portion of the saddle-ride vehicle 10. FIG. 14 is a front view of the main portion of the saddle-ride vehicle 10. FIG. 15 is an enlarged view of FIG. 1 illustrating the periphery of the tank shroud 40.

The tank shroud 40 is attached to the side of the front tank 29f. At this time, the wing body portion 62, the suction opening 54, and the front tank 29f are arranged in this order from the front. The suction opening 54 opens forward. The suction opening 54 overlaps the head pipe 18 in a vehicle body side view (see FIG. 15). The suction opening 54 is located further outward in the vehicle width direction than the fork tube 14a (see FIG. 14). In addition, the wing body portion 62 of the shroud wing 60 overlaps the suction opening 54 in a vehicle body front view (see FIG. 14). Specifically, the wing body portion 62 overlaps the lower portion of the suction opening 54 but not the upper portion, in a vehicle body front view. As illustrated in FIG. 15, the wing body portion 62 is located above the front fender 26. That is, the wing body portion 62 is located above a horizontal plane H1 passing through the upper end of the front fender 26. The upper end of the suction opening 54 is located above the wing body portion 62. The wing body portion 62 and the suction opening 54 are arranged below the front screen 32. That is, the wing body portion 62 and the suction opening 54 are arranged below a horizontal plane H2 passing through the lower end of the front screen 32.

Furthermore, as shown in FIG. 15, in the vehicle body side view, an angle θ1 of the rear end of the wing body portion 62 with respect to the horizontal plane H1 and an angle θ2 of the axis of the head pipe 18 with respect to the horizontal plane H2 are set to be substantially parallel to each other. In addition, in the vehicle body side view, an angle θ3 of the auxiliary line connecting the front inner pointed portion 62c and the rear outer pointed portion 62d with respect to the horizontal plane H1 is smaller than the angle θ2 formed by the head pipe 18 with respect to the horizontal plane H2. Note that the angles θ1 to θ3 are acute angles. As a result, the wing body portion 62 can use the lower surface 62b to guide the traveling wind more accurately to the suction opening 54 and the upper surface 62a to cause the traveling wind to flow to the side of the vehicle body constituted by the vehicle body frame 11 and the like.

As illustrated in FIG. 14, a pair of left and right radiators 35 is disposed between the left and right tank shrouds 40. An engine guard 36 is disposed below the radiators 35. The engine guard 36 covers the power unit 12 from the front. In the present embodiment, the engine guard 36 is formed from CFRP.

FIG. 16 is a functional explanatory diagram of the present embodiment.

When the saddle-ride vehicle 10 travels, traveling wind flows from the front toward the wing body portion 62 of the shroud wing 60 as indicated by arrows A1 and B1. The traveling wind flowing along the upper surface 62a of the wing body portion 62 is guided toward the side of the vehicle body by the upper surface 62a as indicated by an arrow A2, and easily flows along the side of the rider R as indicated by an arrow A3. Therefore, the rider R is less likely to receive resistance from the traveling wind, and the fatigue of the rider R is less likely to accumulate.

In addition, the traveling wind flowing along the lower surface 62b (see FIGS. 9 and 11) of the wing body portion 62 is easily guided toward the suction opening 54 by the lower surface 62b, as indicated by an arrow B2, and to the suction opening 54 of the shroud intake 50, as indicated by an arrow B3. The traveling wind having entered the suction opening 54 flows into the intake space S through the duct 53 and the duct portion S1. This facilitates the air cleaner box 34 to take in an appropriate amount of air. Therefore, a necessary and sufficient amount of intake air can be obtained, and the traveling performance of the saddle-ride vehicle 10 is easily improved.

In the present embodiment, since the suction opening 54 is disposed in the front of the vehicle body which is forward of the front tank 29f and opens forward, there is a possibility that traveling wind excessively flows in. Meanwhile, in the present embodiment, the wing body portion 62 makes it easier to allow the traveling wind to flow toward the side of the vehicle body using the upper surface 62a and to allow only the traveling wind along the lower surface 62b to flow into the suction opening 54, so that the amount of intake air can be easily adjusted to a necessary and sufficient amount.

Here, it is conceivable to provide the suction opening not in the front of the vehicle body but in the side portion of the intake space S. However, if the suction opening is provided in the side portion of the vehicle body, the hole shape of the suction opening may restrict the material of the member of the side portion of the vehicle body or the suction opening may be blocked by the leg of the rider, making it difficult to ensure an appropriate amount of intake air. Meanwhile, in the present embodiment, the suction opening 54 is provided in the front of the vehicle body and the wing body portion 62 is provided forward of the suction opening 54, thereby making it easier to ensure a necessary and sufficient amount of intake air.

Further, in the present embodiment, it is possible to provide the wing shape, namely the wing body portion 62, without protruding outward in the vehicle-body width direction.

As described above, according to the present embodiment to which the present invention is applied, the saddle-ride vehicle 10 includes the front tank 29f, the shroud wing 60, and the shroud intake 50. The shroud intake 50 is provided with the suction opening 54 and disposed on the left and right sides of the front tank 29f, and guides traveling wind below the seat 17. The shroud wing 60 is disposed forward of the shroud intake 50 and has the lower surface 62b that guides traveling wind to the suction opening 54 and the upper surface 62a that causes the traveling wind to flow to the side of the vehicle body constituted by the vehicle body frame 11 and the like. The shroud wing 60 includes the wing body portion 62 further inward in the vehicle-body width direction than the shroud side surface portion 61. The wing body portion 62 includes the front inner pointed portion 62c on the front side in the vehicle-body front-rear direction and on the inside in the vehicle-body width direction, and the rear outer pointed portion 62d on the rear side in the vehicle-body front-rear direction and on the outside in the vehicle-body width direction. The wing body portion 62, the suction opening 54, and the front tank 29f are arranged in this order from the front in a vehicle body side view.

This configuration allows the traveling wind along the lower surface 62b to be guided to the suction opening 54 of the shroud intake 50, so that a necessary and sufficient amount of intake air can be easily obtained. In addition, by causing the traveling wind along the upper surface 62a to flow to the side of the vehicle body constituted by the vehicle body frame 11 and the like, it is possible to suppress the traveling wind from hitting the rider R. Therefore, with the above configuration, it is possible to provide the saddle-ride vehicle 10 in which even if the suction opening 54 is provided in the front of the vehicle body, a necessary and sufficient amount of intake air can be easily obtained and the traveling wind is suppressed from hitting the rider R.

In the present embodiment, the wing body portion 62 partially overlaps the suction opening 54 in a vehicle body front view.

With this configuration, the traveling wind from the front hitting the upper surface 62a can be easily guided to the portion other than the suction opening 54, and it is easy to use the traveling wind along the upper surface 62a and the traveling wind along the lower surface 62b separately.

Furthermore, in the present embodiment, the suction opening 54 partially overlaps the head pipe 18 in the vehicle body side view.

With this configuration, since the suction opening 54 is located forward to such an extent as to overlap the head pipe 18, the shroud wing 60 more easily guides the traveling wind toward the suction opening 54.

Moreover, in the present embodiment, the wing body portion 62 is inclined upward toward the rear of the vehicle body and upward toward the inside in the vehicle-body width direction.

This configuration allows the traveling wind along the lower surface 62b to be more accurately guided to the suction opening 54 of the shroud intake 50, and also allows the traveling wind along the upper surface 62a to flow to the side of the rider R.

In addition, in the present embodiment, the angle changes from the gentle slope 62e to the steeper slope 62f from the front inner pointed portion 62c toward the rear outer pointed portion 62d.

This configuration allows the traveling wind along the lower surface 62b to be more accurately guided to the suction opening 54 of the shroud intake 50, and also allows the traveling wind along the upper surface 62a to flow to the side of the rider R.

In addition, in the present embodiment, the wing body portion 62 has a sweptback wing shape on the inside in the vehicle-body width direction with respect to the shroud side surface portion 61.

This configuration allows the traveling wind along the lower surface 62b to be more accurately guided to the suction opening 54 of the shroud intake 50, and also allows the traveling wind along the upper surface 62a to flow to the side of the rider R.

Further, in the present embodiment, the shroud intake 50 is formed from CFRP.

This configuration can suppress deformation of the shroud intake 50 due to vibration during travel, and also lead to weight reduction of the vehicle body.

In addition, in the present embodiment, the shroud wing 60 is formed from PP.

This configuration can make the shroud wing 60 less likely to crack even in the event of contact/topple during travel and can improve the durability of the shroud wing 60.

### OTHER EMBODIMENTS

The above-described embodiment merely describes one aspect of the present invention and can be optionally modified and applied without departing from the gist of the present invention.

In the above embodiment, the configuration in which the wing body portion 62 is continuously curved and inclined has been exemplified, but the present invention is not limited thereto. For example, the wing body portion 62 may be discontinuously angled. Specifically, the wing body portion 62 may have a configuration in which a ridgeline forming the boundary between inclined surfaces that are inclined at different angles is formed. That is, the wing body portion 62 may be inclined in stages.

The above embodiment exemplifies the saddle-ride vehicle 10 that has the power unit 12 as an internal combustion engine, but the present invention is not limited thereto. For example, the saddle-ride vehicle 10 may be a vehicle that does not have the power unit 12 as an internal combustion engine, that is, an electric vehicle.

Therefore, in the above embodiment, the power unit 12 is exemplified as the power unit that drives the vehicle body, but the power unit may be a power unit including a driving electric motor. Further, instead of the fuel tank 29 serving as the energy storage unit, the energy storage unit may be a battery for driving. Here, in the case of the electric vehicle, the suction opening 54 can be used as a suction opening for taking in the traveling wind in order to cool the power unit and the battery.

In the above embodiments, the description has been given with regard to a motorcycle having the front wheel 13 and the rear wheel 15, as an example of the saddle-ride vehicle 10. However, the present invention is not limited to this. The present invention is applicable to a three-wheel saddle-ride vehicle including two front wheels or two rear wheels or a saddle-ride vehicle including four or more wheels.

### [Configurations Supported by Above Embodiments]

The above embodiments support the following configurations.

(Configuration 1) A saddle-ride vehicle includes an energy storage unit, a shroud wing, and a shroud intake. The shroud intake is provided with a suction opening and disposed on left and right sides of the energy storage unit, and guides traveling wind below a seat. The shroud wing is disposed forward of the shroud intake and has a shroud wing upper surface and a shroud wing lower surface, the shroud wing lower surface guiding traveling wind to the suction opening, the shroud wing upper surface causing the traveling wind to flow to a side of a vehicle body. The shroud wing includes a wing body portion further inward in a vehicle-body width direction than a shroud wing side portion. The wing body portion includes a first pointed portion on a front side in a vehicle-body front-rear direction and on an inside in the vehicle-body width direction, and a second pointed portion on a rear side in the vehicle-body front-rear direction and on an outside in the vehicle-body width direction. The wing body portion, the suction opening, and the energy storage unit are arranged in this order from the front in a vehicle body side view.

This configuration allows the traveling wind along the shroud wing lower surface to be guided to the suction opening of the shroud intake, so that a necessary and sufficient amount of intake air can be easily obtained. In addition, by causing the traveling wind along the shroud wing upper surface to flow to the side of the vehicle body, it is possible to suppress the traveling wind from hitting the rider. Therefore, with the above configuration, it is possible to provide the saddle-ride vehicle in which even if the suction opening is provided in the front of the vehicle body, a necessary and sufficient amount of intake air can be easily obtained and the traveling wind is prevented from hitting the rider.

(Configuration 2) The saddle-ride vehicle according to configuration 1, in which the wing body portion partially overlaps the suction opening in a vehicle body front view.

With this configuration, the traveling wind from the front hitting the shroud wing upper surface can be easily guided to the portion other than the suction opening, and it is easy to use the traveling wind along the shroud wing upper surface and the traveling wind along the shroud wing lower surface separately.

(Configuration 3) The saddle-ride vehicle according to configuration 1 or 2, wherein the suction opening partially overlaps a head pipe in the vehicle body side view.

With this configuration, since the suction opening is located forward to such an extent as to overlap the head pipe, the shroud wing more easily guides the traveling wind toward the suction opening.

(Configuration 4) The saddle-ride vehicle according to any one of configurations 1 to 3, in which the wing body portion is inclined upward toward the rear of the vehicle body and upward toward the inside in the vehicle-body width direction.

This configuration allows the traveling wind along the shroud wing lower surface to be more accurately guided to the suction opening of the shroud intake, and also allows the traveling wind along the shroud wing upper surface to flow to the side of the rider.

(Configuration 5) The saddle-ride vehicle according to any one of configurations 1 to 4, in which an angle changes from a gentle slope to a steeper slope from the first pointed portion toward the second pointed portion.

This configuration allows the traveling wind along the shroud wing lower surface to be more accurately guided to the suction opening of the shroud intake, and also allows the traveling wind along the shroud wing upper surface to flow to the side of the rider.

(Configuration 6) The saddle-ride vehicle according to any one of configurations 1 to 5, in which the wing body portion has a sweptback wing shape on the inside in the vehicle-body width direction with respect to the shroud wing side portion.

This configuration allows the traveling wind along the shroud wing lower surface to be more accurately guided to the suction opening of the shroud intake, and also allows the traveling wind along the shroud wing upper surface to flow to the side of the rider.

(Configuration 7) The saddle-ride vehicle according to any one of configurations 1 to 6, in which the shroud intake is formed from CFRP.

This configuration can suppress deformation of the shroud intake due to vibration during travel, and also lead to weight reduction of the vehicle body.

(Configuration 8) The saddle-ride vehicle according to any one of configurations 1 to 7, in which the shroud wing is formed from PP.

This configuration can make the shroud wing less likely to crack even in the event of a contact/topple during travel and can improve the durability of the shroud wing.

### REFERENCE SIGNS LIST

10 saddle-ride vehicle
11 vehicle body frame (vehicle body)
17 seat
18 head pipe
29f front tank (energy storage unit)
50 shroud intake
54 suction opening
60 shroud wing
61 shroud side surface portion (shroud wing side portion)
62 wing body portion
62a upper surface (shroud wing upper surface)
62b lower surface (shroud wing lower surface)
62c front inner pointed portion (first pointed portion)
62d rear outer pointed portion (second pointed portion)
62e gentle slope
62f steeper slope

What is claimed is:

1. A saddle-ride vehicle comprising: an energy storage unit; a shroud wing; and a shroud intake,
the shroud intake being provided with a suction opening and disposed on left and right sides of the energy storage unit, the shroud intake guiding traveling wind below a seat,
the shroud wing being disposed forward of the shroud intake and having a shroud wing upper surface and a shroud wing lower surface, the shroud wing lower surface guiding traveling wind to the suction opening, the shroud wing upper surface causing the traveling wind to flow to a side of a vehicle body,
the shroud wing including a wing body portion further inward in a vehicle-body width direction than a shroud wing side portion,
the wing body portion including a first pointed portion on a front side in a vehicle-body front-rear direction and on an inside in the vehicle-body width direction, and a second pointed portion on a rear side in the vehicle-body front-rear direction and on an outside in the vehicle-body width direction,
the wing body portion, the suction opening, and the energy storage unit being arranged in this order from the front in a vehicle body side view.

2. The saddle-ride vehicle according to claim 1, wherein
the wing body portion partially overlaps the suction opening in a vehicle body front view.

3. The saddle-ride vehicle according to claim 1, wherein
the suction opening partially overlaps a head pipe in the vehicle body side view.

4. The saddle-ride vehicle according to claim 1, wherein
the wing body portion is inclined upward toward the rear of the vehicle body and upward toward the inside in the vehicle-body width direction.

5. The saddle-ride vehicle according to claim 1, wherein
an angle changes from a gentle slope to a steeper slope from the first pointed portion toward the second pointed portion.

6. The saddle-ride vehicle according to claim 1, wherein
the wing body portion has a sweptback wing shape on the inside in the vehicle-body width direction with respect to the shroud wing side portion.

7. The saddle-ride vehicle according to claim 1, wherein
the shroud intake comprises CFRP.

8. The saddle-ride vehicle according to claim 7, wherein
the shroud wing comprises PP.
